(19) United States
(12) Patent Application Publication
(10) Pub. No.: US 2008/0281927 A1
(43) Pub. Date: Nov. 13, 2008

(54) Summarization tool and method for a dialogue sequence

(75) Inventors: Lucretia H. Vanderwende, Sammamish, WA (US); Michael Gamon, Seattle, WA (US); Rajatish Mukherjee, Issaquah, WA (US)

Correspondence Address: WESTMAN CHAMPLIN (MICROSOFT CORPORATION), SUITE 1400, 900 SECOND AVENUE SOUTH, MINNEAPOLIS, MN, 55402-3244, US

(73) Assignee: Microsoft Corporation, Redmond, WA (US)

(21) Appl. No.: 11/801,806

(22) Filed: May 11, 2007

(51) Int. Cl. G06F 15/16

(52) U.S. Cl. 709/206

(57) ABSTRACT

The application discloses embodiments of a summarization tool for a dialogue sequence or message thread. In the embodiments disclosed, the summarization tool utilizes a topic shift component to identify a topic start to define a topic group for the dialogue sequence or message thread. A summary component uses the topic start to generate a summary output for the topic group of the dialogue sequence or message thread. In illustrated embodiments, the summary output includes one or more of a context summary, a thread summary, and scope data or information.

### BACKGROUND

Reference is hereby made to co-pending and commonly assigned U.S. patent application Ser. No. ______, filed _entitled “SUMMARIZATION OF ATTACHED, LINKED OR RELATED MATERIALS”, the content of which is hereby incorporated by reference in its entirety.

Business and other professionals communicate using a variety of electronic applications or devices such as voice mail, instant messaging, electronic mail as well as telephone and video conferencing. Typically, such professionals must ascertain the relevancy of each communication or message, which can be difficult if there is a large volume of related communications or messages.

For example, typically professionals or electronic mail users receive multiple electronic mail messages each day. Some of the messages may be part of a larger message thread including an original message and one or more associated messages linked to the original message. Typically, the user has to review each of the messages in the message thread to understand the context of more recent messages in the thread. In some cases not all of the messages in the message thread are related to the topic of interest to the user. If the user is a new recipient, it is particularly burdensome to review each of the messages in the message thread and in particular messages unrelated to the user's topic of interest.

The discussion above is merely provided for general background information and is not intended to be used as an aid in determining the scope of the claimed subject matter.

### SUMMARY

The application discloses a summarization tool and method having application for a dialogue sequence or message thread. In embodiments disclosed, the summarization tool invokes a topic shift component to detect a topic shift in the dialogue sequence or message thread. As disclosed the tool utilizes the topic shift outputted by the topic shift component to generate a summary output for a topic group defined relative to the topic shift.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 schematically illustrates an embodiment of a computing environment in which embodiments of the application can be implemented.

FIG. 2 schematically illustrates an embodiment of a summarization tool for a dialogue sequence.

FIG. 3 schematically illustrates another embodiment of a summarization tool for a dialogue sequence.

FIG. 4 schematically shows an illustrated embodiment of a message thread of an electronic message system.

FIG. 5 schematically illustrates a clustering application for associating cluster labels or identifiers for messages in a message thread of the type illustrated in FIG. 4.

FIG. 6 is a flow chart illustrating steps for determining a topic start for messages in a message thread.

FIG. 7 illustrates an embodiment of the summarization tool invoking a summary component configured to generate a context summary for the topic start message.

FIG. 8 illustrates an embodiment of the summarization tool invoking a summary component configured to generate a thread summary for messages of a topic group.

FIG. 9 illustrates an embodiment of a summarization tool invoking a summary component configured to generate a scope summary for messages of a topic group.

FIG. 10 illustrates an embodiment of a graphical user interface display including a display portion for summary output for a topic group of a message thread.

FIG. 11 illustrates an embodiment of a summarization tool that invokes a summary component to output reference or attachment summaries for a topic group.

FIG. 12 illustrates an embodiment of a graphical user interface display including a display portion for reference or attachment summary output.

### DETAILED DESCRIPTION

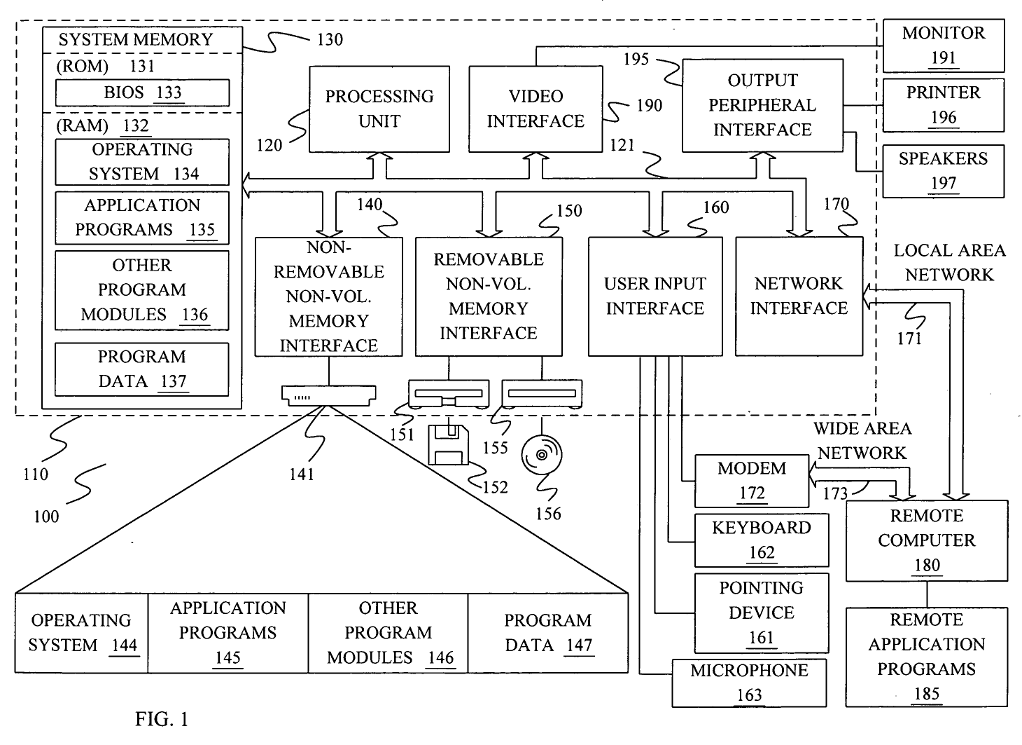

With reference to FIG. 1, an exemplary system for implementing some embodiments includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 is operated in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used. Although FIG. 1 includes an illustrative environment, application is not limited to the illustrated environment.

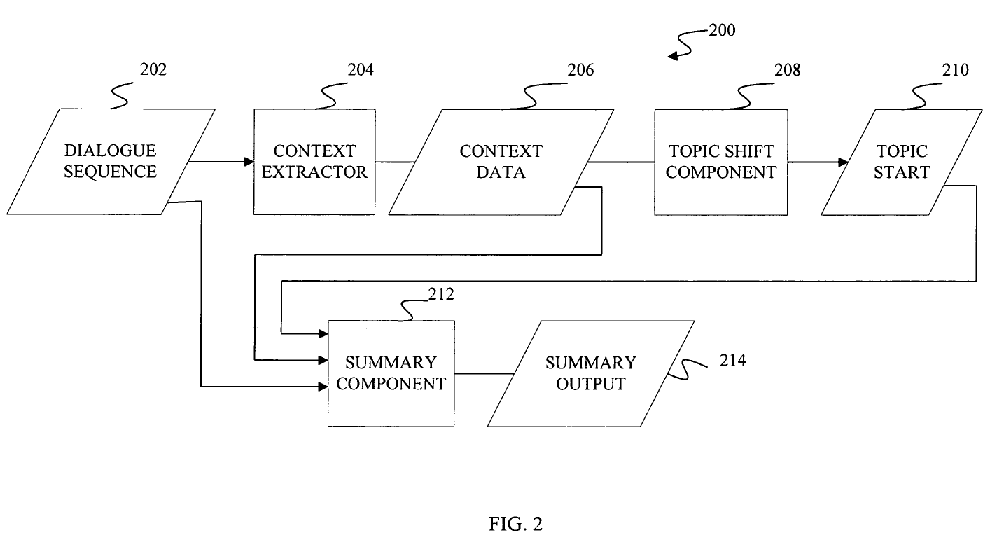

FIG. 2 illustrates an embodiment of an application that is implementable on a computer readable medium in a computing environment of the type illustrated in FIG. 1. As shown the application includes a topic summarization tool 200 for an electronic dialogue sequence 202. In the illustrated embodiment of FIG. 2, the dialogue sequence 202 is a text sequence such a text message thread.

As shown, the illustrated tool 200 invokes a context extractor 204 that extracts context data 206 for exchanges or messages in the dialogue sequence or thread. The context data includes high frequency words and other context data, such as addressee data, subject references, and information relating to attachments as described herein. Additionally, the context data 206 includes metadata, such as category data, that is used to identify context or topic information for the dialogue sequence or thread. The context data 206 is provided to a topic shift component 208 to detect topic shifts with respect to context of the dialogue sequence or thread.

The topic shift component 208 outputs a topic start 210 to define a topic group of the dialogue sequence or thread. A summary component 212 is invoked to generate a summary output 214 for the topic group of the dialogue sequence 202 associated with or linked to the topic start 210. In the illustrated embodiment, the summary component 212 utilizes context data 206 for messages in the topic group to generate the summary output 214 for the topic group of the dialogue sequence.

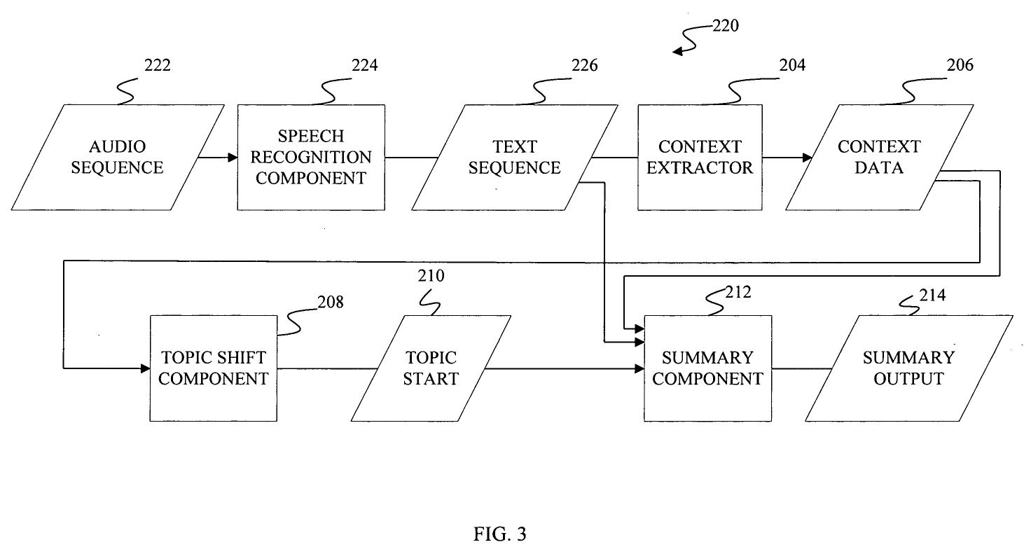

FIG. 3 illustrates an alternate embodiment in which the topic summarization tool 220 is configured to receive an audio sequence 222 such as a voice message thread, telephone or video-conference sequence or other audio dialogue media. In the illustrated embodiment the topic summarization tool 220 invokes a speech recognition component 224 to recognize the audio sequence and output a recognized text sequence 226 for the input audio sequence 222. As previously described with respect to FIG. 2, context data 206 is extracted from the text sequence 226 by context extractor 204. The context data 206 is utilized by the topic shift component 208 to detect a topic shift and output a topic start 210. As shown, summary component 212 is invoked to generate a summary output 214 for the topic group of the dialogue sequence or message thread utilizing context data 206 for messages in the topic group associated with or linked to the topic start 210.

The input dialogue sequence previously described can be a message thread, such as a text or audio message thread or combination of text and audio messages or exchanges as well as other dialogue sequences. For example, the dialogue sequence can be an electronic mail, instant message, text message or voice message thread or combination of electronic mail, instant messaging, text message and voice message exchanges.

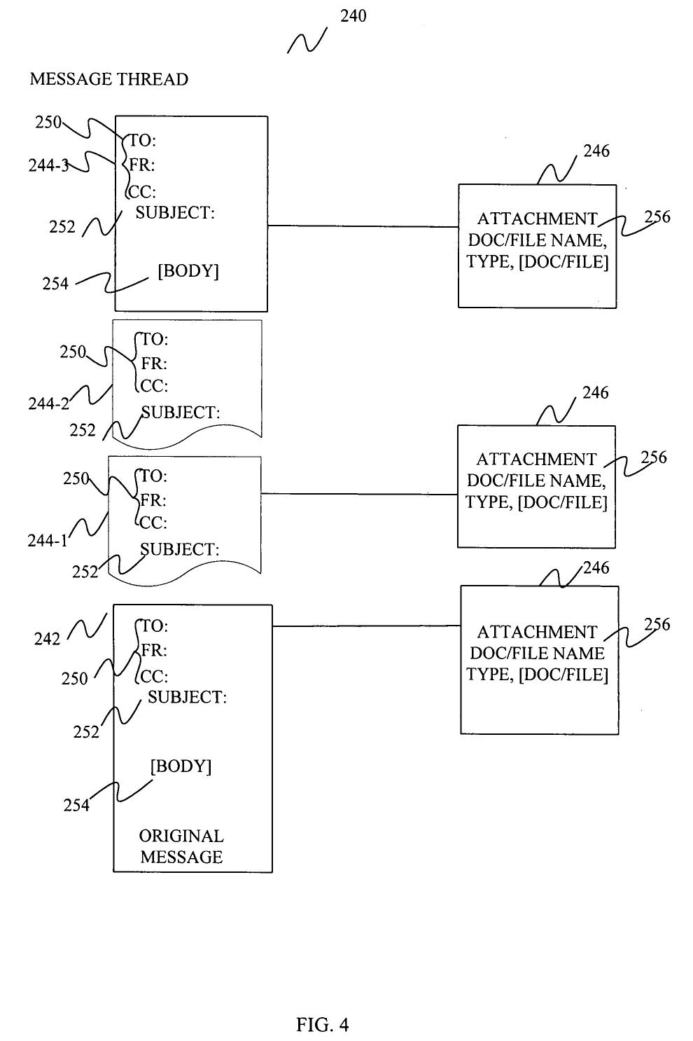

FIG. 4 illustrates a message thread 240 for an electronic email system although application of embodiments of the illustrated tool is not limited to an electronic mail thread or particular dialogue sequence as discussed above. The illustrated message thread 240 in FIG. 4 includes an original message 242 and one or more associated messages, which as illustrated in FIG. 4 include associated messages 244-1, 244-2, 244-3. In the illustrated embodiment, associated messages 244-1, 244-2, 244-3 are linked to the original message 242 as a reply or forward message. Original message 242 and associated messages 244-1, 244-2, 244-3 in the illustrated message thread 240 include attachments 246 such as a document or web page attachment.

As shown in FIG. 4, the original message 242 and associated messages 244-1, 244-2, 244-3 of the message thread 240 include one or more fields or portions. In the embodiment shown, the message portions include one or more address fields 250, such as for example, TO: FROM: . . . , CC: . . . , and BCC: . . . , subject field 252, a message body 254, and an attachment portion 256. The attachment portion 256 illustratively includes document/file name, type and encoded text of the attachment document or file. The context extractor 204 illustrated in FIGS. 2-3 can extract data from one or more message or attachment portions to generate context data 206 for the topic shift component 208 and/or summary component 212 as previously described.

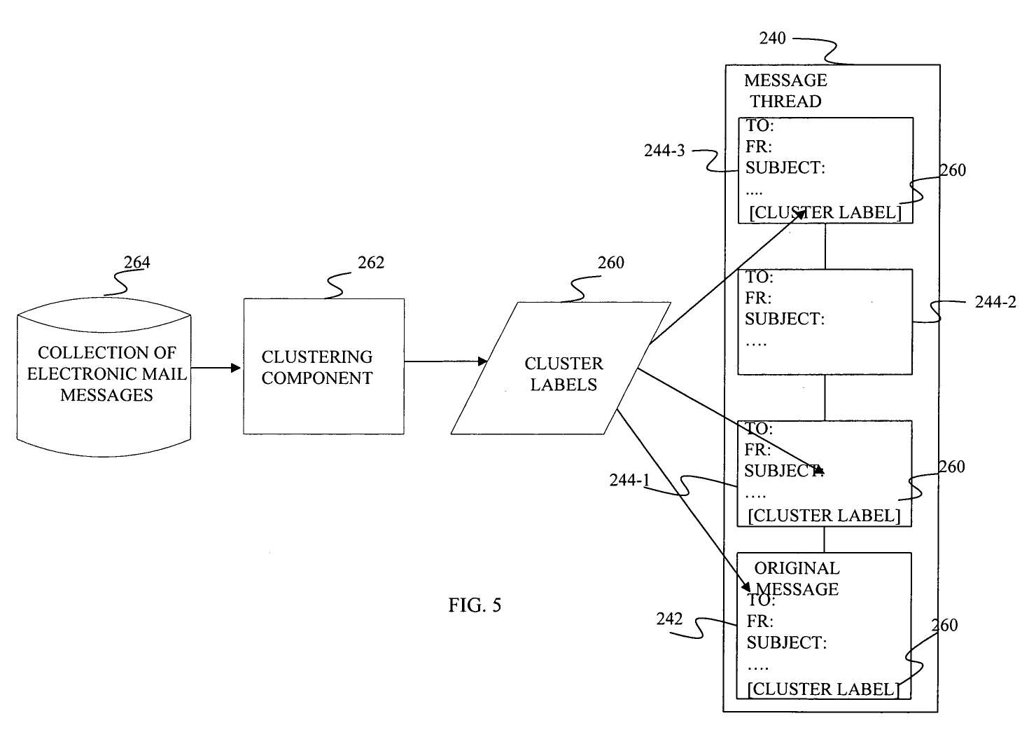

In addition to the message portions illustrated in FIG. 4, the context data 206 can include metadata as previously described as well as cluster labels 260 associated with one or more messages in the message thread 240 as shown in FIG. 5. As shown, the cluster labels 260 are generated by a clustering component 262 which processes a collection of electronic mail messages from an inbox or other data store 264 and generates cluster labels 260 based upon relatedness of the e-mail messages to a similar topic or concept. In an illustrated embodiment, the cluster labels 260 are utilized by the topic shift component 208 alone or in combination with other context data 206 to detect a topic shift in the message thread 240 as previously described.

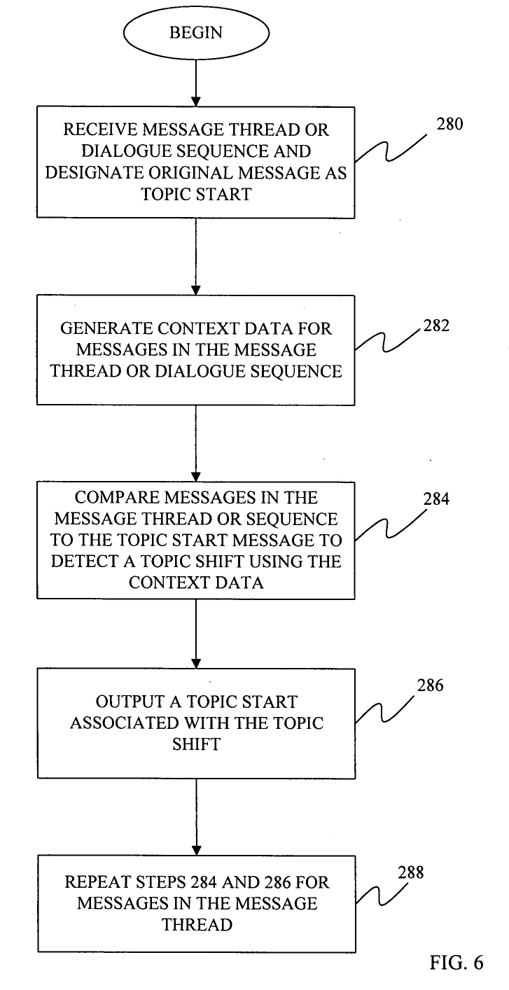

FIG. 6 illustrates a flow chart of an embodiment including steps for identifying and outputting a topic start 210 utilizing a topic shift component 208 as previously described. As shown in FIG. 6, in step 280 a message thread 240 is received and an original message 242 in the message thread 240 is designated as the topic start 210. In step 282 context data 206 is generated for messages in the message thread 240. The context data 206 is utilized to compare messages in the message thread 240 to the topic start 210 to detect a topic shift as shown in step 284. If a topic shift is detected, the topic shift message is designated as the topic start 210 for a topic group of the message thread 240 as shown in step 286. As shown in step 288, the steps of 284 and 286 are repeated for messages in the message thread to identify one or more topic groups in the message thread based upon one or more topic starts outputted by the topic shift component 208 as previously described.

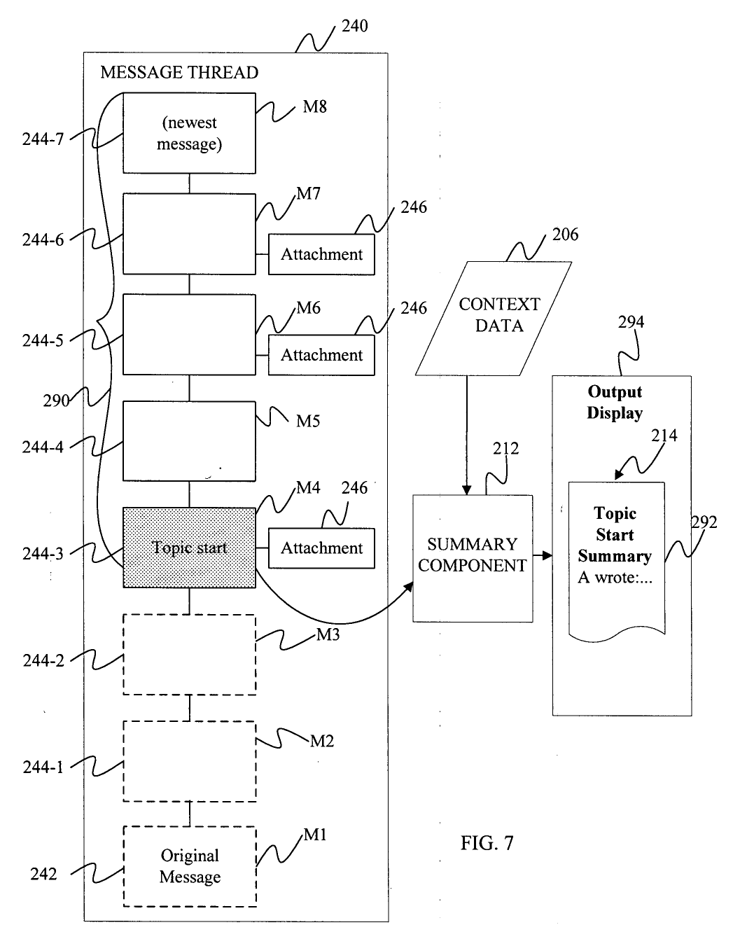

In the embodiment illustrated in FIG. 7, the message thread 240 includes original message 244-1 and associated message 244-1 through 244-7 to define chronologically ordered messages M1-M8. As shown in FIG. 7 M4 is a topic start message for topic group 290 including messages M4-M8. As previously described, summary component 212 is invoked by the topic summarization tool described herein to generate a summary output 214 for the topic group 290 of the message thread 240.

In the embodiment of FIG. 7, the summary output 214 includes a topic start summary 292 which is generated by the summary component 212 based upon summarization of the topic start message M4 using context data 206 and known summarization methods as will be appreciated by those skilled in the art. For example, in an illustrative embodiment, the summary component 212 generates a topic start summary 292 by selecting the n most important sentences from the topic start message M4 or alternatively by creating a summary text that reflects the important content of the topic start message M4.

In illustrated embodiments, the topic start summary 292 is in the form “A wrote or said . . . ”, followed by a summary of the text or content of the message, where A refers to the author or sender of the message. In the illustrated embodiment of FIG. 7, the context summary is outputted to display 294. Although a particular summary format is shown, application is not limited to the particular summary format shown.

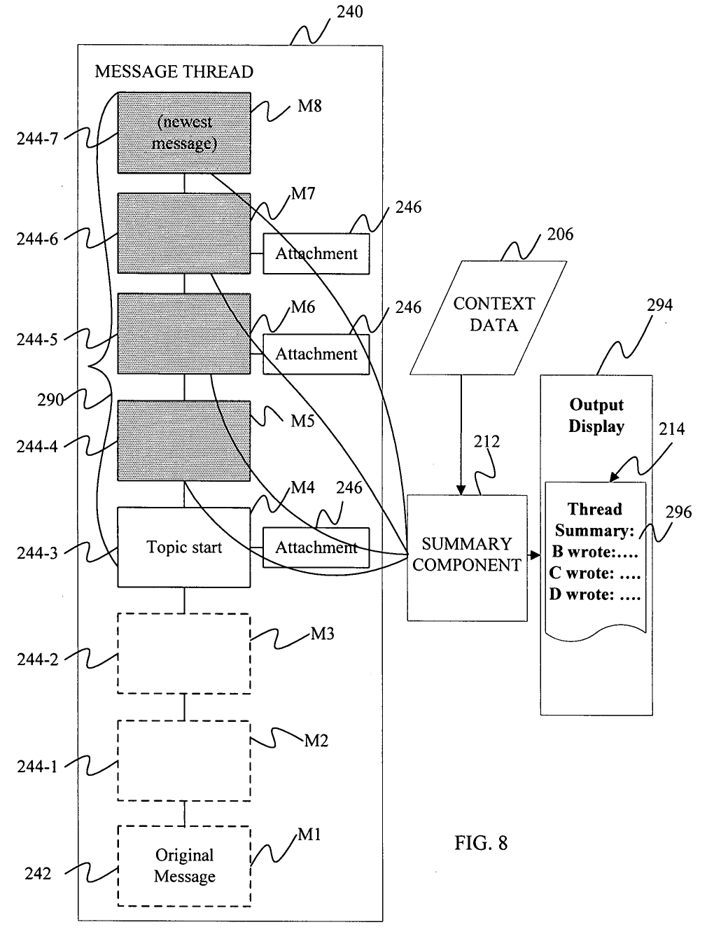

In the embodiment illustrated in FIG. 8, the messages of the topic group 290 are processed by the summary component 212 to generate a thread summary 296 for the topic group messages 290. The thread summary 296 includes a summary of the content of each of the associated messages in the topic group, which in FIG. 8 includes messages M5-M8. The summary component 212 summarizes each of the messages M5-M8 using known summarization methods as previously described. In an illustrative embodiment, the summary component 212 generates a thread summary 296 by selecting the n most important sentences from messages M5-M8 of the topic group 290 or alternatively by creating a summary text that reflects important content of the associated messages of the topic group 290. As previously described in illustrated embodiments, the summary component 212 utilizes context data 206 to determine important content or sentences of the messages, as well as utilizing the topic start identified for the messages in the topic group that is being summarized.

In the illustrated embodiment the thread summary 296 is outputted as message summaries in the form of “B wrote or said . . . , C wrote or said . . . “, D wrote or said . . . and E wrote or said . . . ” where B-E refer to the author or sender of the respective messages in the topic group 290 followed by the summary of the text or content of the messages. The separate message summaries of the thread summary 296 can be presented in reverse chronological order, in which the summary for the most recent message is first or in chronological order, where the summary for the earliest message in the topic group 290 is listed first. Although a particular output format is shown, application is not limited to the particular format shown.

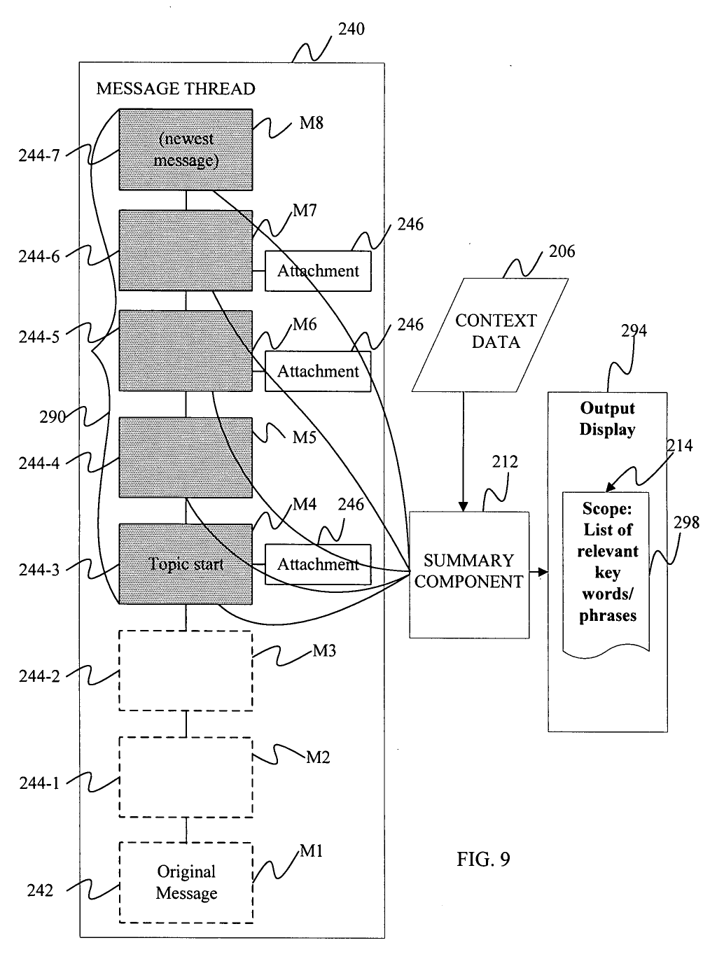

In another embodiment illustrated in FIG. 9, the summary component 212 is configured to output scope information or data 298 for the topic group 290. The scope information or data 298 includes keyword(s), high frequency words or phrases and/or cluster labels 260 for messages of the topic group 290. The scope information or data 298 is generated utilizing context data 206 for the topic group, for example high frequency words or cluster labels 260, as previously described.

In the illustrated embodiments of FIGS. 7-9, the summary component 212 provides a summary output 214 for a single topic group 290, however, any number of topic groups can be identified and the summary component 212 can generate a summary output 214 for any one or combination of topic groups. For example, in one embodiment, the summary component 212 generates summary output 214 for the chronologically most recent topic group 290 or alternatively for each topic group of the message thread 240.

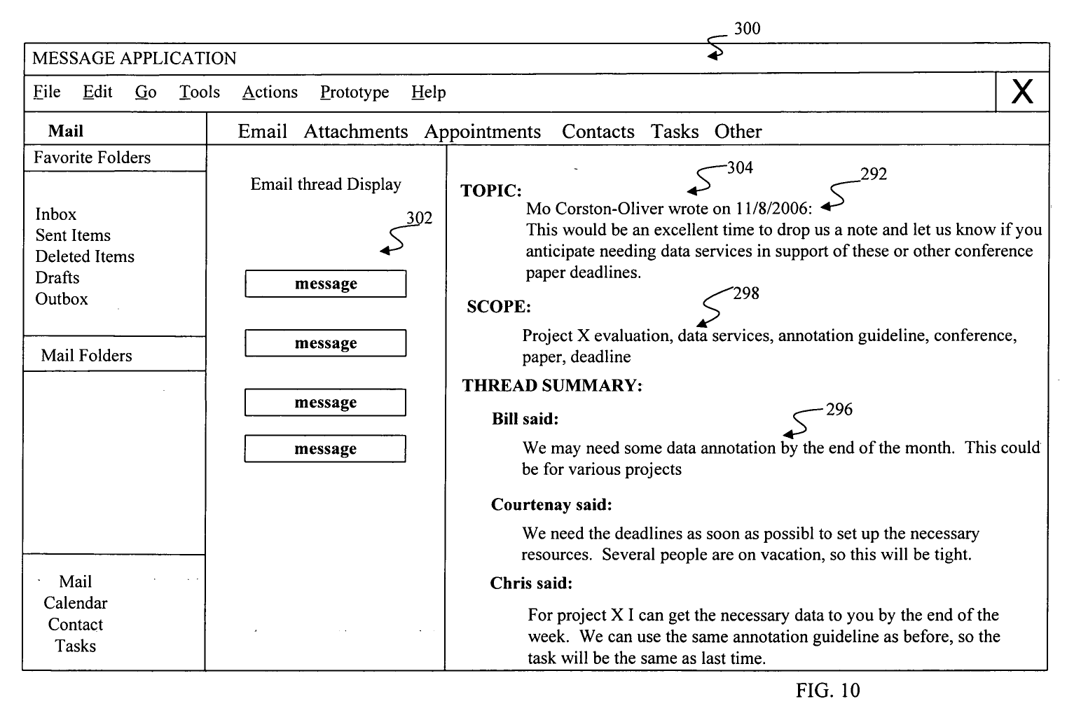

In an illustrated embodiment, the output display 294 for the summary output 214 is a graphical user interface such as a graphical user interface 300 for an electronic mail application as illustrated in FIG. 10. The graphical user interface 300 illustrated in FIG. 10 includes multiple screen display portions. In the illustrated embodiment, the multiple screen display portions include a first display portion 302 to display messages of the message thread 240 or inbox and a second display portion 304 to display the summary output 214 generated by the summarization tool. Messages in the display portion 302 can be displayed in a list format or other display format. In the illustrated embodiment, the second display portion 304 includes a topic start summary 292, thread summary 296 and scope information or data 298, however output is not limited to each of the summary formats shown.

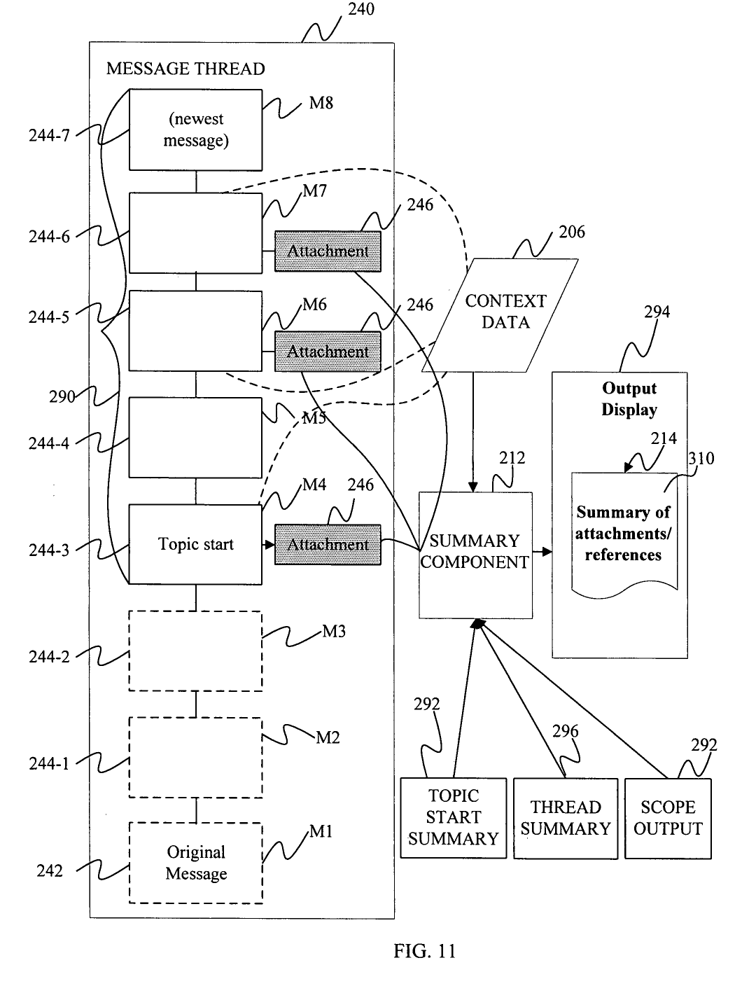

As previously described, in illustrated embodiments, the message thread 240 includes one or more attachments 246. In the embodiment illustrated in FIG. 11, the summarization tool invokes the summary component 212 to generate summary output 214 for attachments 246 linked to messages in the topic group 290 using known summarization methods or techniques. As shown in FIG. 11, the summary component 212 receives and utilizes context data 206 to output reference summaries 310 for attachments 246 in the topic group 290. As shown, the context data 206 includes context data for messages (e.g., 244-3, 244-5, 244-7) linked to the attachments 246 and in addition other context data such as thread information and metadata from various sources. In the illustrated embodiment, the summary component 212 also receives one or more of the output topic start summary 292, thread summary 296 and scope information or data 298 to generate the reference summaries 310.

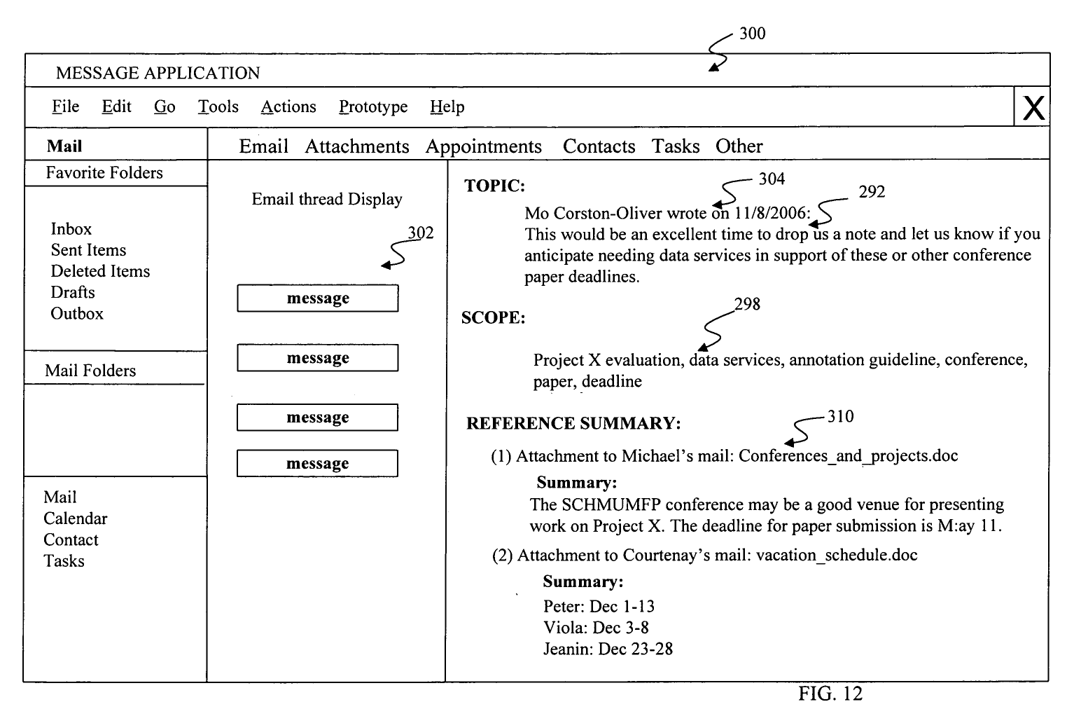

The reference summaries 310 are outputted to output display 294 which in FIG. 12 is a graphical user interface 300 having multiple display portions 302, 304. As shown, the multiple display portions includes first display portion 304 for messages of the message thread 290 or inbox and second display portion 304 to display the reference summary output 310 alone or in combination with other summary output 214 as shown.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Further, applications have been described with specific reference to an electronic mail message thread however, application is not limited to the specific dialogue sequence described in the illustrated examples.

What is claimed is:

1. An application implementable on a computer readable medium comprising:
a tool to summarize an electronic dialogue sequence configured to invoke a topic shift component that is configured to utilize context data for the electronic dialogue sequence to detect a topic shift for one or more dialogue exchanges of the dialogue sequence and output a topic start for a topic group of the dialogue sequence; and
a summary component configured to receive the topic start and utilize the topic start to generate a summary output for one or more exchanges of the topic group of the dialogue sequence.

2. The application of claim 1 wherein the dialogue sequence includes one or more of a tele-conference, instant message, electronic mail or voice mail exchange.

3. The application of claim 1 wherein the dialogue sequence comprises an audio input and the tool is configured to invoke a speech recognition component to output text recognition for the audio input.

4. The application of claim 1 wherein the dialogue sequence is a message thread including an original message and one or more messages linked to the original message.

5. The application of claim 4 wherein the summary component is configured to generate the summary output based upon summarization of one or more messages in the topic group of the message thread.

6. The application of claim 4 wherein the summary output includes a context summary generated based upon summarization of a topic start message of the topic group.

7. The application of claim 4 wherein the summary output includes a thread summary generated based upon a summarization of one or more messages linked to the topic start.

8. The application of claim 4 wherein the summary output utilizes a format comprising A wrote or said . . . , where A corresponds to the author or sender of a message in the topic group and followed by a summary of a content of the message.

9. The application of claim 1 wherein the context data for the topic group of the dialogue sequence is utilized to output scope data or information for the topic group.

10. The application of claim 4 wherein the context data includes data associated with the original message or the one or messages linked to the original message in the message thread or one or more attachments linked to the original message or the one or more messages linked to the original message in the message thread.

11. The application of claim 4 wherein the context data includes at least one of keywords or key phrases in the original message or the one or more messages linked to the original message, or one or more attachments linked to the original message, or to the one or more messages linked to the original message in the message thread.

12. The application of claim 4 wherein the context data includes cluster data or labels for messages of the topic group generated for a collection of electronic mail messages in a data store.

13. A method comprising:
receiving a dialogue sequence and using context data extracted from the dialogue sequence to output a topic start for a topic group of the dialogue sequence; and
generating a summary output for the topic group of the dialogue sequence.

14. The method of claim 13 wherein the dialogue sequence comprises a message thread and comprising:
designating an original message in the message thread as the topic start;
comparing messages in the message thread to a topic start message to detect a topic shift; and
outputting the topic start associated with the topic shift.

15. The method of claim 14 wherein generating the summary output comprises:
summarizing the topic start message; and
outputting a context summary for the topic start message.

16. The method of claim 14 wherein generating the summary output comprises:
summarizing the messages in the topic group associated with the topic start; and
outputting a thread summary for the messages in the topic group.

17. The method of claim 14 wherein generating the summary output comprises:
extracting keywords or phrases from messages in the topic group associated with the topic start; and
outputting the keywords or phrases from the messages in the topic group.

18. The method of claim 14 wherein one or more of the messages in the message thread includes an attachment and comprising:
summarizing one or more attachments linked to one or more messages in the topic group; and
outputting a reference summary for the one or more attachments.

19. The method of claim 13 and further comprising:
generating cluster labels; and
utilizing the cluster labels to output at least one of the topic start or the summary output.

20. The method of claim 13 wherein the dialogue sequence comprises a message thread and the summary output is in the form of “A wrote or said . . . ” where A is the author or sender of a message in the message thread and followed by a summary of a content of the message.
